(19) United States
(12) Patent Application Publication
(10) Pub. No.: US 2005/0109052 A1
(43) Pub. Date: May 26, 2005

(54) Systems and methods for conditioning air and transferring heat and mass between airflows

(76) Inventors: Walter F. Albers, Paradise Valley, AZ (US); Yijun Yuan, Shaoxing (CN)

Correspondence Address: MICHAEL WINFIELD GOLTRY, 340 EAST PALM LANE, SUITE 260, PHOENIX, AZ, 85004, US

(21) Appl. No.: 10/955,215

(22) Filed: Sep. 30, 2004

Related U.S. Application Data
(60) Provisional application No. 60/507,822, filed on Sep. 30, 2003.
(60) Provisional application No. 60/519,163, filed on Nov. 12, 2003.

(51) Int. Cl. G11B 3/00; G11B 20/10; H04N 5/76; F28C 1/00; F28D 5/00; F25D 17/06; G11B 27/36; G11B 5/09; F25D 23/00

(52) U.S. Cl. 62/271; 62/94; 62/121; 62/314

(57) ABSTRACT

An air conditioning system includes a first chamber having a plurality of first sectors, a second chamber having a plurality of second sectors, a first airflow device forming a first airflow through the first chamber, a second airflow device forming a second airflow through the second chamber, and a heat and mass transfer substance flowing in a plurality of the first and second sectors, the substance interacting with the first and second airflows through the first and second chambers. Thermal inducement apparatus thermally interacts with the substance establishing a thermal gradient between the first sectors and a thermal gradient between the second sectors providing a heat and mass energy gradient for the first airflow through the first sectors and a reversed heat and mass energy gradient for the second airflow through the second sectors. Plumbing is provided, which moves the substance throughout the system.

### CROSS-REFERENCE TO RELATED APPLICATION

This application claims the benefit of U.S. Provisional Application Ser. No. 60/507,822, filed 30 Sep. 2003, and U.S. Provisional Application Ser. No. 60/519,163, filed 12 Nov. 2003.

### FIELD OF THE INVENTION

The present invention relates to air conditioning systems and methods.

### BACKGROUND OF THE INVENTION

A compressor-based air conditioner incorporates a compressor that compresses a refrigerant causing it to become a hot, high-pressure gas. This hot gas is sent through a set of coils where it dissipates its heat condensing into a liquid. The liquid flows through an expansion valve, and in the process expands becoming a cold, low-pressure gas. The cold gas moves through another set of coils that allow the gas to absorb heat and reduce the temperature of a stream of air. This cooling operation is psychrometrically fixed and inflexible; the air temperature being reduced with this reduction controlling the amount of moisture removal. From the standpoint of energy efficiency, these air conditioners use only the expanded gas for cooling while they exhaust the energy contained in the hot, high pressure gas to the atmosphere or to a cooling tower. In environments containing a relatively high humidity, moisture removal can be assisted by employing desiccants, which may be a solid, gel, or liquid. However, these desiccant systems provide a fixed adiabatic exchange between the moisture level and temperature of the air. Further, compound usage of compressor and desiccant devices has not led to integrated systems providing efficient utilization of energy nor have the various components been combined into a low cost system. Other deficiencies in the art will readily occur to those skilled in the art.

### SUMMARY OF THE INVENTION

A preferred embodiment of an air conditioning system is disclosed, which includes a first chamber having a plurality of first sectors; a second chamber having a plurality of second sectors; a first airflow device forming a first airflow through the first chamber; a second airflow device forming a second airflow through the second chamber; a heat and mass transfer substance flowing in a plurality of the first and second sectors, the substance interacting with the first and second airflows through the first and second chambers; thermal inducement apparatus thermally interacting with the substance establishing a thermal gradient between the first sectors and a thermal gradient between the second sectors providing a heat and mass energy gradient for the first airflow through the first sectors and a reversed heat and mass energy gradient for the second airflow through the second sectors; and plumbing moving the substance between at least one of the first sectors and at least one of the second sectors. An energy exchange device is provided, which causes the substance to provide heat and mass transfer between the first air flow and the second air flow. In one embodiment, the energy exchange device includes a carrier that is wetted with the liquid desiccant. In accordance with the principle of the invention, the substance includes a liquid desiccant. A first channel permits the substance to migrate between ones of the first sectors, and a second channel permits the substance to migrate between ones of the second sectors. In a particular embodiment, the thermal inducement apparatus includes a compressor. In another embodiment, the thermal inducement apparatus includes a plurality of compressors. In the case of thermal inducement apparatus including a plurality of compressors, each of the compressors is thermally connected to plumbing that is adapted and arranged to exchange the substance between one of the first sectors and one of the second sectors. A heat transfer conduit of the thermal inducement apparatus provides heat transfer at one of the sectors. In another embodiment, a heat transfer conduit of the thermal inducement apparatus provides heat transfer at one of the sectors in conjunction with the substance providing heat and mass transfer at the one of the sectors. In a particular embodiment, the first airflow has a first flow rate, and the second airflow having a second flow rate, in which the first flow rate is different from the second flow rate.

Another preferred embodiment of an air conditioning system is disclosed, which includes air movement apparatus developing a first airflow through a first chamber and a second airflow through a second chamber, the first chamber having a first sector and the second chamber having a second sector; a substance capable of transferring heat and mass; an energy exchange device causing the first airflow to interact with the substance at the first sector and the second airflow interacting with the substance at the second sector, and forming a heat and mass transfer exchange between the first and second airflows; thermal inducement apparatus thermally interacting with the substance in the first sector and the substance in the second sector causing an energy change transmitted to the first airflow and an opposite energy change transmitted to the second airflow; and plumbing providing a flow of the substance of the first sector to the second sector, and a flow of the substance of the second sector to the first sector. In one embodiment, the energy exchange device includes a carrier that is wetted with the liquid desiccant. In accordance with the principle of the invention, the substance includes a liquid desiccant. In a particular embodiment, the first airflow has a first flow rate, and the second airflow has a second flow rate, in which the first flow rate is different from the second flow rate. The first sector is one of a plurality of sectors of the first chamber, in which the first airflow interacts with the substance at each of the plurality of sectors of the first chamber. A first channel permits the substance to migrate between ones of the sectors of the first chamber. The second sector is one of a plurality of sectors of the second chamber, in which the second airflow interacts with the substance at each of the plurality of sectors of the second chamber. A second channel permits the substance to migrate between ones of the sectors of the second chamber. In one embodiment, the thermal inducement apparatus includes a compressor. In another embodiment, the thermal inducement apparatus includes multiple compressors.

In accordance with the principle of the invention, a preferred method includes applying a heat and mass transfer substance to sectors of a first chamber; applying the heat and mass transfer substance to sectors of a second chamber; intermixing the substance between first chamber sectors and second chamber sectors; adapting the substance of the first chamber sectors to contact air flowing into the space; adapting the substance of the second chamber sectors to contact air flowing from the space; establishing a negative thermal gradient between sectors in the first chamber; and establishing a positive thermal gradient between sectors in the second chamber. In one embodiment, the method further includes implementing thermal gradients with a thermal inducement device. In another embodiment, the method further includes implementing thermal gradients with multiple thermal inducement devices.

Consistent with the foregoing summary of various preferred embodiments of the invention, and the ensuing disclosure, which are to be taken together, the invention also contemplates associated apparatus/system and method embodiments.

### BRIEF DESCRIPTION OF THE DRAWINGS

Referring to the drawings:

FIG. 1 is a schematic representation of a system for conditioning air, constructed and arranged in accordance with the principle of the invention;

FIG. 2 is a partially schematic vertical sectional view of an embodiment of a sector of an airflow chamber of the system of FIG. 1;

FIG. 3 is a schematic view of another embodiment of a system for conditioning air, constructed and arranged in accordance with the principle of the invention;

FIG. 4 is a schematic view of still another embodiment of system for conditioning air, constructed and arranged in accordance with the principle of the invention;

FIG. 5 is a schematic view of yet still another embodiment of a system for conditioning air, constructed and arranged in accordance with the principle of the invention;

FIG. 6 is a side elevational view of a duct assembly for use with a system for conditioning air that is constructed and arranged in accordance with the principle of the invention;

FIG. 7 is a partially schematic sectional view of an energy exchange device for use with a system for conditioning air that is constructed and arranged in accordance with the principle of the invention; and

FIG. 8 is a partially schematic vertical sectional view of an embodiment of a sector of an airflow chamber of the system of FIG. 1.

### DETAILED DESCRIPTION OF A PREFERRED EMBODIMENT

Systems and methods for conditioning air are disclosed, which are useful for providing conditioned air to buildings, such as residential buildings, commercial buildings, and the like, and which use a circulating liquid desiccant as a mechanism to transfer heat and mass (i.e., moisture) between air flows, such as an airflow moving air from inside a building to the atmosphere, and an airflow moving air from the atmosphere into the building. The liquid desiccant can be a single desiccant or a mixture of different desiccants. It is to be understood that the term desiccant is intended to include not only a single liquid desiccant but also a mixture of two or more different liquid desiccants. Water is a desiccant and may be used, if desired.

Preferably, a circulating desiccant is used to efficiently exchange the heat and moisture content of an air stream discharged from a habitable area with an incoming ambient air stream so that its temperature and humidity content more nearly proximate the air conditions prevalent in the habitable space. In an air cooling mode of operation of the invention, this air is then contacted with desiccant that is chilled by heat exchange with a compressor's released evaporator energy, thereby reducing its temperature and increasing its receptiveness to evaporate its moisture into the desiccant. The discharged air stream, being that expelled from the habitat and passing through the circulating desiccant, is contacted with the chilled desiccant following its heat exchange with the compressor's condenser heat, thereby utilizing compressor energy once again. The increased temperature now achieved by this air stream allows acceptance of vapor evaporated from the desiccant. In alternate mode of operation, compressor energies are redirected or reversed such that the present invention may provide a heating function.

Preferably, the present invention employs an integrated combination of distinct energy transfer mechanisms including heat and mass transfer (sensible transfer, and latent transfer), which together efficiently and economically change the energy content of air, namely, its heat content and its mass or moisture content. Latent energy refers to the moisture in air, which can be measured by the wet bulb temperature of air, and sensible energy refers to the heat content of air, which can be measured by the dry bulb temperature of air.

Air maintains a constant enthalpy or energy content, and converting the energy contained in air from sensible energy to latent energy is an adiabatic process. According, changing the energy content of air involves both heat transfer and mass transfer. In accordance with this disclosure, heat transfer is the movement of energy that cools or heats a fluid (liquid or gas), or that evaporates a liquid or condenses a vapor in which the movement of energy occurs at a gas/liquid interface. Mass transfer is the movement of an evaporating liquid from a liquid phase to a gas phase, or movement of a condensing vapor from a gas phase to a liquid phase.

The invention incorporates first and second chambers each for conducting an air stream. Where appropriate, the chambers are thermally connected. Thermally connected in this context means that fluids (air or liquid) from each chamber are brought into close proximity on opposite sides of a heat transfer mechanism causing heat can transfer from one chamber to the other chamber. The air streams through the chambers operate under nearly constant pressures, in which any change in the pressures is caused by frictional losses. After exiting the first chamber and before entering the second chamber, an energy change to this air is primarily elicited by it mixing with other air which generally induces alteration to both its heat content and to its moisture content. This energy change has two effects. First, it provides a temperature and mass energy differential between the air in the chambers. Second, it assists development of a temperature range between one end of a chamber to the other. These changes cause the air to have a constantly changing equilibrium value, which is receptive to receiving or losing energy. An equilibrium value is a vapor-liquid equilibrium or temperature. A vapor liquid equilibrium can be said to exist when the escape tendency of the species from liquid to a vapor phase is exactly balanced with the escape tendency of a species from a vapor to a liquid phase at the same temperature and pressure.

Liquid desiccant is applied to part or all of one or both chambers. The liquid desiccant can be water, a hydroscopic fluid such as but not limited to lithium bromide (LiBr), lithium chloride (LiCl) or mixtures thereof, etc.

Application of the liquid desiccant is segmented, which means: (1) that the chamber is segmented along its length into sequential sectors that may be equal or unequal in width; (2) that uncontrolled mixing of the liquid desiccant is generally minimized between sectors; (3) that the liquid desiccant exiting a sector has different temperature and concentration than when it entered the sector, that while wetting a sector, the bulk of the liquid desiccant remains within a sector a required time for (a) their temperature to follow the temperature of the air within that sector and/or the temperature another segmented wetting of a second chamber thermally connected to the first chamber sector, and (b) a predetermined level of evaporation or condensation to occur into or from any present air stream as induced by the vapor-liquid imbalance associated with the air and liquid desiccant; and (4) that the sectors of a chamber are sequentially ordered so that heat transfer to and from a chamber generally occurs in a manner so as to continually change the desiccant temperature in one direction along the chamber length.

Migratory movement of the liquid desiccant between a plurality of sectors can be provided. This migratory movement means (1) the actual movement of the liquid desiccant into and out of a sector where the liquid desiccant, when exiting a sector, has at least one selected property that is different than the same selected property when the heat and mass transfer substance entered the sector, where a selected property is the temperature or the concentration of the liquid desiccant; and (2) that some portion of the liquid desiccant of a sector exits a sector to enter an adjacent sector. This migratory movement between sectors allows a liquid desiccant property to influence the same property of an adjacent sector, this sequence being repeated throughout a plurality of wetted sectors obtaining at least one overall directional movement of these liquid desiccant combined with sequential change in at least one selected property. The rate of migratory movement between sectors is controlled by addition to or subtraction from the chamber liquid desiccant by any means causing the required time duration of the liquid desiccant within a wetting sector to be achieved.

In the first energy exchange arrangement, there is provided an energy exchange device in which alternate chambers are connected with a substance capable of receiving or releasing heat and mass energy to air as the air passes through the chambers, in which the heat and mass transfer substance utilized is liquid desiccant. A particular arrangement of developing heat and mass transfer exchange between air of the first chamber and air of the second chamber is accomplished by a heat and mass transfer substance passing from one chamber to the other by its direct movement from a sector in one chamber to a sector in the second chamber and referred to herein as a circulating heat and mass transfer substance.

Other arrangements can be utilized provided they encompass the direct utilization of the heat and mass transfer substance in which one air stream transfers some portion of the heat and mass energy to the substance and the substance, in turn, transfers this heat and mass energy to a second air stream. These arrangements can employ permeable membranes wetted with the heat and mass transfer substance wherein the substance cycles through the membrane. In this arrangement the two air flows can flow concurrently, countercurrently, crosscurrently, etc.

A second arrangement of developing heat and mass transfer exchange between air of the first chamber and air of the second chamber is provided by applying thermal inducement to heat and mass transfer substances in at least two sectors of at least one chamber. Thermal inducement is generally provided by vapor compression systems presently utilized in air conditioning applications. Temperature ranges created are dependent on refrigerant pressures as well as on heat exchange potentials. Properly configured, most of the developed temperature range can be heat exchanged with heat and mass transfer substances.

Using the compressed condition as well as the expanded condition of the refrigerant in alternate chambers by means of heat exchange, thermal inducement provides for increase or decrease in temperature of a heat and mass transfer substance in one chamber while creating the opposite change in temperature to a heat and mass transfer substance in the other chamber. This temperature change also prompts an imbalance between the heat and mass transfer substance found within a sector and the air passing through the sector causing (a) the air temperature to be altered and (b) a level of evaporation or condensation to occur into or from the air as induced by the vapor-liquid imbalance associated with the air and the heat and mass transfer substance. Evaporation or condensation occurring in the sectors of each chamber causes the heat and mass transfer substance to tend toward achieving an equilibrium condition with its adjacent air stream. To avoid manifestation of this occurrence a portion of this heat and mass transfer substance is circulated to a sector of the other chamber wherein, because of the opposite thermally induced temperature, a reversed mass transfer is induced.

Mitigation of sector equilibrium between its heat and mass transfer substance and its adjacent air stream also can occur by direct substance transfer between sectors of the two chambers. A heat and mass transfer substance is circulated between a sector of one chamber and a sector of the other chamber. In this second arrangement, the heat and mass transfer substance again transfers heat and mass between two air streams. However, the significant impetus for this exchange is the heat exchange to the substance afforded by its thermal interaction with fluids of the thermal inducement devices.

In operation as an air cooler and dehumidifier, there is reduction in heat and mass energy from hot and humid outside air as this air passes through and exits the first chamber. After absorbing heat and humidity from an indoor space, the air, still initially lower in energy than the outside ambient air, passes through the second chamber while gaining in heat and mass energy from the first chamber. Specifically, the incoming ambient air first contacts a sector where the heat and mass transfer substance is in circulation with a sector of the second chamber in which the air most often is of lower temperature and humidity. This circulation of heat and mass transfer substance induces an equilibrium imbalance between the heat and mass transfer substance and air passing through the sector of each chamber. The incoming ambient air is generally reduced in temperature and humidity and the heat and mass transfer substance, now with this increased heat and vapor content, is rebalanced in the second chamber by exchanging its heat with and condensing vapor into the passing air. This exchange, again using a circulation of the heat and mass transfer substance and a sector in each the first and second chambers, may be repeated especially in climates where outside ambient air during the summer months contains a high heat and vapor content.

Following next in its passage to a subsequent sector of the first chamber, the air is contacted by a heat and mass transfer substance now chilled by a colder fluid from a thermal inducement apparatus. This again causes imbalance to the vapor-liquid equilibrium motivating the warmer air to give up its heat and condense its vapor into the heat and mass transfer substance. A flow of this heat and mass transfer substance is directed to a sector of the second chamber nearer its air exit. The heat and mass transfer substance in this sector receives heat from the thermal inducement apparatus. As the passing air increases in temperature through contact with the heat and mass transfer substance, the vapor-liquid equilibrium is again altered allowing the warmer air to accept evaporation of water vapor from the heat and mass transfer substance. As more than one thermal inducement devices can be employed, this sequence can be repeated causing passing air in the first chamber to become cooler and contain less moisture while providing for increased evaporation in the second chamber. In the event that condensation needs of the first chamber are insufficient to balance possible evaporation in the other chamber from an energy balance standpoint, especially given induced heat from the thermal inducement device's mechanical compression, a balance can be struck by providing an increased airflow through the chambers for causing increased heat and mass transfer from the heat and mass transfer substance. Alternatively, an auxiliary condensing coil element may be employed using air exiting the second chamber.

Alternate configurations of the present invention are also possible. For instance, sectors related to thermal inducement devices in one of the two chambers may be combined. When two or more sectors are utilized, a migratory flow of the heat and mass transfer substance may be embraced or alternately, a direct flow of the heat and mass transfer substance may be affected between sectors of the first and second chambers.

In operation as an air heater in climates conducive to heat pump operation, there is an increase in heat and mass energy to outside air as it passes through and exits the first chamber. Concurrently, the expelled air from the habitat space, which is generally higher in energy than the outside ambient air, passes through the second chamber while giving up its heat and mass energy to the first chamber. Specifically, incoming ambient air first contacts a sector where the heat and mass transfer substance is in circulation with a sector of the second chamber in which the air is of higher temperature and humidity. This circulation induces an equilibrium imbalance between the heat and mass transfer substance and air passing through the sector of each chamber.

The incoming ambient air is generally increased in temperature and humidity and the associated heat and mass transfer substance, now with reduced heat and vapor content, is rebalanced in the second chamber by gaining heat from and evaporating moisture from the passing air. This exchange, again using a circulation of heat and mass transfer substance and a sector in each the first and second chambers, may be repeated. Following next in its passage through a subsequent sector of the first chamber, the air is contacted by a heat and mass transfer substance raised in temperature by a warmer fluid from the thermal inducement device. This again causes imbalance to the vapor-liquid equilibrium inducing the colder air to receive heat. This sector configuration is repeated to cause the passing air in the first chamber to become still warmer. Unless there is need to maintain the two air streams separate, it is generally economical to blend a portion of the exiting air with the incoming ambient air.

Incorporation of multiple thermal inducement devices allows indoor comfort conditions to be achieved while concurrently maintaining minimal utilization of energy. Operation of these devices may be sequenced so as to vary thermal capacity. As example, none need be activated during seasonal periods when outside air temperatures are sufficient to maintain indoor comfort set-points, then depending upon harshness of the outdoor climate, progressing to single stage engagement then to full employment as maintenance of indoor comfort conditions dictate. Also, the multiple thermal inducement device configuration allows for a reduced temperature spread between its evaporation and condensation functions when compared with single thermal inducement device utilization. From a theoretical point of view, this reduction should increase compressor efficiency.

The apparatus for implementing the invention consists of two chambers generally placed one above the other. Separate mechanical means, which can be low pressure blowers, are utilized for air movement through each chamber. Each sector contains a sump and in most cases incorporates a separate pump to distribute heat and mass transfer substance thereby developing liquid to air interface in each sector. This interface incorporates methods to increase air and heat and mass transfer substance contact area. Thermal inducement is provided by one or more compressor units with their refrigerant flows directed to heat exchange means in the first and second chambers.

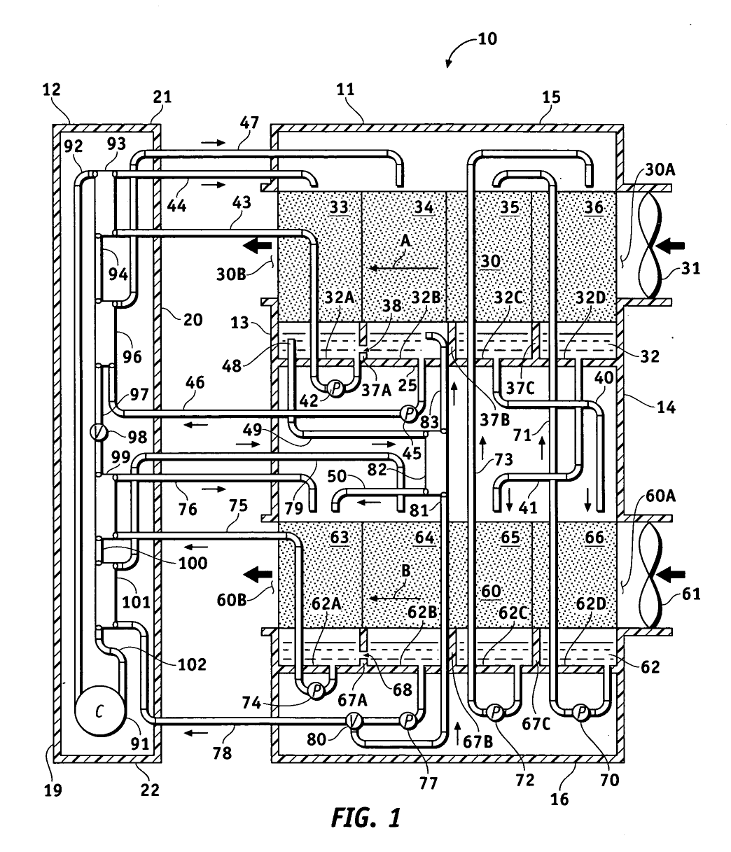

Referring now to the drawings, in which like reference characters indicate corresponding elements throughout the several views, attention is first directed to FIG. 1 in which there is seen a system 10 for conditioning air including air handling apparatus 11 and thermal inducement apparatus 12. Air handling apparatus 11 and thermal inducement apparatus 12 are depicted generally and schematically in FIG. 1. In normal practice, air handling apparatus 11 and thermal inducement apparatus 12 are maintained in a common housing. However, they can be maintained in separate housings or locations, if desired. Furthermore, as long as the various components of the invention cooperate together in the manner herein described, they may be separated from one another if desired, or provided in any suitable combinations. Nevertheless, for ease of discussion and description of system 10, air handling apparatus 11 and thermal inducement apparatus 12 are presented as separate components.

By way of example, air handling apparatus 11 and thermal inducement apparatus 12 are depicted as two rectangular housings, in which air handling apparatus 11 has opposing end walls 13 and 14, and opposing top and bottom walls 15 and 16, and thermal inducement apparatus 12 has opposing end walls 19 and 20, and opposing top and bottom walls 21 and 22. A dividing wall 25 interconnects end walls 13 and 14, and separates air handling apparatus 11 into opposing chambers 30 and 60. The various walls of air handling apparatus 11 and thermal inducement apparatus 12 are preferably fashioned of sheet material made of steel, aluminum, plastic, or the like.

Chamber 30 has an inlet 30A and an opposing outlet 30B. Chamber 60 has an inlet 60A and an opposing outlet 60B. An air movement blower or fan 31 is located at inlet 30A, and moves air through chamber 30 in the direction indicated by the arrowed line A from a habitable space at inlet 30A to the atmosphere at outlet 30B. Fan 31 can be located elsewhere, if desired, and any number of fans can be incorporated for moving air through chamber 30 and by way of pushing air through chamber 30 and/or by way of pulling air through chamber 30.

Another air movement blower or fan 61 is located at inlet 60A, and moves air through chamber 60 in the direction indicated by the arrowed line B from the atmosphere at inlet 60A to the habitable space at outlet 60B. Fan 61 can be located elsewhere, if desired, and any number of fans can be incorporated for moving air through chamber 60 and by way of pushing air through chamber 60 and/or by way of pulling air through chamber 60.

Chamber 30 is divided into sectors 33, 34, 35, and 36, which are disposed in series from outlet 30B to inlet 30A. Chamber 60 is divided into sectors 63, 64, 65, and 66, which are disposed in series from outlet 60B to inlet 60A. In the preferred embodiment disclosed herein, chamber 30 incorporates four sectors, and chamber 60 incorporates four sectors. Chambers 30 and 60 can each incorporate less or more sectors consistent with this disclosure and depending on specific needs. Chambers 30 and 60 can be generally equal in size and shape, or differently sized and shaped. The airflow through chamber 30 has a flow rate, and the airflow through chamber 60 has a flow rate. The flow rates of the opposing airflows through chambers 30 and 60 can be substantially the same, or different, and this will normally depend on the relative sizes of chambers 30 and 60 and/or the configuration of the one or more devices used to move air through the respective chambers 30 and 60.

Chambers 30 and 60 are positioned such that the respective airflows therethrough flow concurrently. However, it is to be understood that this configuration and arrangement of chambers 30 and 60 is shown only as a matter of example, and that chambers 30 and 60 can be arranged such that the respective airflows run crosscurrently relative to one another, or in other directions relative to one another.

Chambers 30 and 60 incorporate basins/sumps 32 and 62, respectively, which maintain a heat and mass transfer substance, namely, a liquid desiccant. Sump 32 is divided with sidewalls 37A, 37B, and 37C into sump sectors 32A, 32B, 32C, and 32D. As clearly depicted in FIG. 1, sump sector 32A associates with sector 33, sump sector 32B associates with sector 34, sump sector 32C associates with sector 35, and sump sector 32D associates with sector 36. A channel or opening 38 through sidewall 37A permits the liquid desiccant in sump 32 to migrate between sump sectors 32A and 32B. Sidewalls 37B and 37C are solid and do not permit the liquid desiccant to migrate and flow therebetween sump sectors 32B and 32C, and sump sectors 32C and 32D.

Sump 62 is divided with sidewalls 67A, 67B, and 67C into sump sectors 62A, 62B, 62C, and 62D. As clearly depicted in FIG. 1, sump sector 62A associates with sector 63, sump sector 62B associates with sector 64, sump sector 62C associates with sector 65, and sump sector 62D associates with sector 66. A channel or opening 68 through sidewall 67A permits the liquid desiccant in sump 62 to migrate between sump sectors 62A and 62B. Sidewalls 67B and 67C are solid and do not permit the liquid desiccant to migrate and flow therebetween sump sectors 62B and 62C, and sump sectors 62C and 62D.

In a preferred practice, sumps 32 and 62 are molded from a thermoplastic material, or other non-metallic and/or metallic material having corrosion resistant characteristics, for avoiding seams and minimizing corrosion. Sectors 33, 34, 35, and 36 of chamber 30, and sectors 63, 64, 65, and 66 of chamber 60, incorporate one or more mechanisms that increase the available surface of contact between air flowing through chambers 30 and 60 and liquid desiccant dispersed into chambers, such as conventional media disposed therein of the type commonly found in evaporator coolers, beads, small saddles or rings found in small cooling towers, and even one or more nozzles for dispensing the liquid desiccant therein in the form of small droplets.

System 10 incorporates a device/system/apparatus, i.e., plumbing, for providing circulation and exchange of the liquid desiccant throughout system 10 and, moreover, between chambers 30 and 60, and between chambers 30 and 60 and thermal inducement apparatus 12, in which the liquid desiccant is the mechanism that transfers heat and mass (i.e., moisture) between the air flows through chambers 30 and 60. The plumbing used to circulate the liquid desiccant includes, as will be herein disclosed, a network of pipes/conduits and pumps for transferring the liquid desiccant from place to place throughout system 10. In accordance with the principle of the invention, the plumbing facilitates liquid desiccant circulation and transfer between sump sector 62D and sump sector 32C, sump sector 62C and sump sector 32D, and between sump sectors 32A-B and sump sectors 62A-B. In accordance with the principle of the invention, the plumbing also includes a network of pumps and conduits for providing heat transfer between the liquid desiccant in sump sectors 32A-B and thermal inducement apparatus 12, and for providing heat transfer between the liquid desiccant in sump sectors 62A-B and thermal inducement apparatus 12. In the preferred embodiment disclosed herein, thermal inducement apparatus 12 has a hot side and a cold side, in which the pumps and conduits of the plumbing are adapted and arranged providing heat transfer between the liquid desiccant in sump sectors 32A-B and the hot side of thermal inducement apparatus 12, and for providing heat transfer between the liquid desiccant in sump sectors 62A-B and the cold side of thermal inducement apparatus 12. As a result of this arrangement, the airflow through chamber 30 becomes increasingly hot and moist, whereas the airflow through chamber 60 becomes increasingly cold and dry. This effect can be reversed by reversing the operation of thermal inducement apparatus 12 making the once hot side the cold side and the once cold side the hot side, or by way of reversing the plumbing, namely, plumbing sump sectors 32A and 32B for heat transfer with the cold side of thermal inducement apparatus 12 and plumbing sump sectors 62A and 62B for heat transfer with the hot side of thermal inducement apparatus 12.

Turning now to the specifics of the plumbing as depicted in FIG. 1, sump sector 62D is plumped to sump sector 32C, in which liquid desiccant from sump sector 62D of sector 66 is pumped by pump 70 through conduit 71 and directly discharged therefrom into the top of sector 35 and into the air stream passing therethrough and through chamber 30, which is then collected in sump sector 32C and then directed outwardly therefrom through conduit 40 and into the top of sector 66 and into the air stream passing therethrough and through chamber 60, and which is then collected in sump sector 62D.

In climates of high temperature and humidity, a second set of sectors that directly exchange liquid desiccant may be added, if desired, and system 10 incorporates this, which will now be discussed. With this addition, sump sector 62C is plumbed to sump sector 32D, in which liquid desiccant from sump sector 62C of sector 65 is pumped by pump 72 through conduit 73 and directly discharged therefrom into the top of sector 36 and into the air stream passing therethrough and through chamber 30, which is then collected in sump sector 32D and then directed outwardly therefrom through conduit 41 and into the top of sector 65 and into the air stream passing therethrough and through chamber 60, which is then collected in sump sector 62C. This interaction of the liquid desiccant with the airflows through chambers 30 and 60 at sectors 36 and 65 is an energy exchange device that produces heat and mass transfer between the respective airflows, in accordance with the principle of the invention.

It is to be understood that material utilized in the connecting together the conduits and the pumps of the plumbing herein described are fashioned from readily available, corrosion-resistant material, such as PVC conduit, ABS conduit, CPVC conduit, or the like. Also, discharge of liquid desiccant at the top of a sector may be direct (as shown) or may incorporate additional distribution tubes or sprays to improve the disposition of the liquid desiccant into the sectors as herein described.

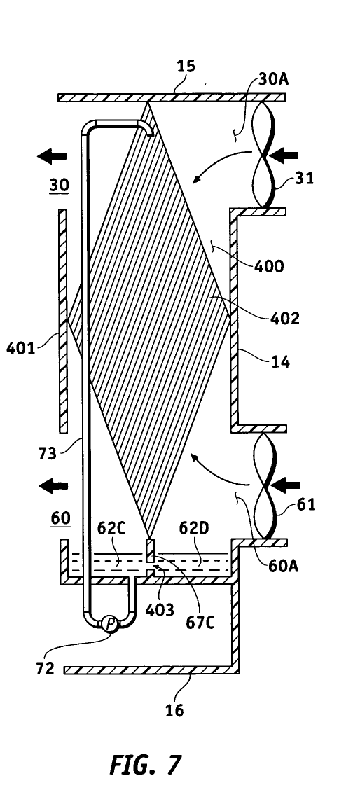

Again, the interaction of the liquid desiccant with the airflows through chambers 30 and 60 at sectors 35 and 66, and the interaction of the liquid desiccant with the airflows through chambers 30 and 60 at sectors 36 and 65, are each a device that produces heat and mass transfer between the respective airflows, in accordance with the principle of the invention. When these devices are combined, they can be together considered a device. As previously intimated, it is to be understood that other arrangements can be utilized for providing this heat and mass transfer provided they encompass the direct utilization of the heat and mass transfer substance in which one air stream transfers some portion of the heat and mass energy to the substance and the substance, in turn, transfers this heat and mass energy to a second air stream. These arrangements, as previously explained, can employ permeable membranes wetted with the heat and mass transfer substance wherein the substance cycles through the membrane, in which the two air flows can flow concurrently, countercurrently, crosscurrently, etc. An example of such an arrangement of an energy transfer devices is set forth in FIG. 7.

With momentary attention directed to FIG. 7, an alternate embodiment of an energy exchange device is depicted, which replaces the energy exchange device previously explained incorporating sectors 35,36,65,66, sump sectors 32C,32D,62C,62D, and the plumping for use in coupling the liquid desiccant to sectors 66 and 35, and sectors 65 and 36, which are all removed with the exception of sump sectors 62C and 62D. Additional elements common to the energy exchange device set forth in FIG. 1, however, do exist, including inlet 30A, blower or fan 31, inlet 60A, blower or fan 61 pump 72 and conduit 73. Unlike the previously-described energy exchange device, a cavity 400 is defined between top wall 15, sump sectors 62C and 62D, end wall 14, and an additional opposing end wall 401. In cavity 400 there is suspended a carrier 402. Carrier 402 is a membrane or membrane-like component made of liquid-absorbent paper, microporous plastic material, or the like. In operation, liquid desiccant from sump sector 62C is pumped by pump 72 through conduit 73 and directly discharged therefrom onto the top of carrier 402 thus wetting carrier 402 with the liquid desiccant. As the liquid desiccant is applied to carrier 402, carrier 402 will soak it up, in which the liquid desiccant will migrate and flow throughout the body of the carrier 402. When carrier 402 becomes saturated with the liquid desiccant, it is free to drip or otherwise flow into the sump (i.e., sump sector 62C and/or sump sector 62D). Pump 72 can provide carrier 402 with a continuous flow of liquid desiccant, or be operated periodically so as to ensure carrier 402 is wetted with the liquid desiccant. In this regard, pump can operate on a continuous basis, or periodically whether by way of manual operation or with the use of a timer or other similar devices that is programmed to activate pump periodically in accordance with a predetermined schedule.

Carrier 402 is disposed in the air flow through chamber 30 produced by fan or blower 31, and is also disposed in the air flow through chamber 60 produced by fan or blower 61. Intake air passing into cavity 400 through inlet 30A and intake air passing into cavity 40 through inlet 60A interact with carrier 402 and with the liquid desiccant supported by carrier 402. Carrier 402 divides cavity 400 and directs intake air from inlet 30A to chamber 60, and directs intake air from inlet 60A to chamber 60, in which the intake air at inlet 30A is from the atmosphere and the intake air at inlet 60A is from the inside of a building. Carrier 402 not only divides cavity 400, but also substantially prevents the respective air flows from mixing. Some mixing of the air flows may occur, in some instances. However, small instances of mixing of the air streams will not interfere with the operation of the energy transfer device depicted in FIG. 7, nor will it interfere with the operation of the remaining portions of the system.

Because carrier 402 is wetted with the liquid desiccant, the respective air streams will interact with the liquid desiccant, which will cause a heat and mass transfer to occur between it and the respective air streams. Sump sectors 62C and 62D maintain the liquid desiccant and collect the liquid desiccant from carrier 402, and there is a channel or opening 403 through sidewall 67C that permits the liquid desiccant to migrate between sump sectors 62C and 62D as needed. If desired, sidewall 67C can be eliminated to form a single sump. Again, the interaction of the liquid desiccant supported by carrier 402 with the airflows through chambers 30 and 60 is an energy exchange device that produces heat and mass transfer between the respective airflows, in accordance with the principle of the invention.

In FIG. 7, the air flows flow crosscurrently relative to one another. If desired, the air flows can be configured to flow countercurrently relative to one another.

Thermal inducement device 12 is a compressor-based system that, in this specific embodiment, incorporates a single compressor designated at 91. Compressor 91, like all compressors of the various embodiments of the invention, is a thermal inducement device. Compressor 91 is conventional, in that it simply compresses a refrigerant thus making the refrigerant hot. The compressed, hot refrigerant flows through conduit 92, which is generally fabricated of metal, to a refrigerant-to-liquid heat exchanger 93, which is a multi-plate device made of stainless steel or other suitable material. Following heat exchange at exchanger 93, the refrigerant flows through conduit 94 to refrigerant-to-liquid heat exchanger 96, where further heat is transferred. Upon refrigerant exit via conduit 97, the refrigerant expands following its flow through pressure expansion valve 98 thus becoming very cold. The refrigerant, now significantly reduced in temperature, is then directed from valve 98 to refrigerant-to-liquid heat exchanger 99 via a conduit, and from there through conduit 100 to refrigerant-to-liquid heat exchanger 101, with both heat exchangers 99 and 101 providing heat transfer. The refrigerant then returns through conduit 102 to compressor 91 for recompression and recirculation. It will be understood that the side of thermal inducement apparatus 12 upstream of valve 98 is the hot side of thermal inducement apparatus 12, and that the side of thermal inducement apparatus 12 downstream of valve 98 is the cold side of thermal inducement apparatus 12.

Sector 33 of chamber 30 is thermally connected to the hot side of thermal inducement apparatus 12 by a flow of the liquid desiccant, which is provided by pump 42 pumping the liquid desiccant from sump sector 32A through conduit 43 to refrigerant-to-liquid heat exchanger 93 where it passes the refrigerant, in which an exchange of heat is produced between the flow of the refrigerant and the flow of the liquid desiccant at exchanger 93, and in which the liquid desiccant, now heated, passes to the top of sector 33 through conduit 44 and into the air stream passing through chamber 30, which is then collected in sump sector 32A. In the case in which multiple sectors in each chamber are influenced by thermal inducement, sector 34 is also thermally connected to the hot side of thermal inducement apparatus 12 by a flow of the liquid desiccant provided by a pump 45 pumping the liquid desiccant from sump sector 32B through conduit 46 to refrigerant-to-liquid heat exchanger 96 where it passes the refrigerant, in which an exchange of heat is produced between the flow of the refrigerant and the flow of the liquid desiccant at exchanger 96, and in which the liquid desiccant, now heated, passes to the top of sector 34 through conduit 47 and into the air stream passing through chamber 30, which is then collected in sump sector 32B.

Sector 63 of chamber 60 is thermally connected to the cold side of thermal inducement apparatus 12 by a flow of the liquid desiccant, which is provided by pump 74 pumping the liquid desiccant from sump sector 62A through conduit 75 to refrigerant-to-liquid heat exchanger 99 where it passes the refrigerant, in which an exchange of heat is produced between the flow of the refrigerant and the flow of the liquid desiccant at exchanger 99, and in which the liquid desiccant, now cooled, passes to the top of sector 63 through conduit 76 and into the air stream passing through chamber 60, which is then collected in sump sector 62A. In the case in which multiple sectors in each chamber are influenced by thermal inducement, sector 64 is also thermally connected to cold side of thermal inducement apparatus 12 by a flow of the liquid desiccant provided by a pump 77 pumping the liquid desiccant from sump sector 62B through conduit 78 to refrigerant-to-liquid heat exchanger 101 where it passes the refrigerant, in which an exchange of heat is produced between the flow of the refrigerant and the flow of the liquid desiccant at exchanger 101, in which the liquid desiccant, now cooled, passes to the top of sector 64 through conduit 79 and into the air stream passing through chamber 60, which is then collected in sump sector 62B.

In accordance with this arrangement, as there develops change in the mass composition (i.e., water content) of the liquid desiccant in sectors 63 and 64 in the opposite concentration from liquid desiccant in sectors 33 and 34, an interchange flow between chambers 30 and 60 is necessary to maintain this compositional change. A valve 80 is provide in conduit 78, which redirects a portion of the liquid desiccant flow from pump 77 through conduit 81 and through a heat exchanger 82 and from there into sump sector 32B through conduit 83.

When more than one sector of a given chamber of system 10 is thermally connected to thermal inducement apparatus 12, the liquid desiccant flow from chamber 30 to chamber 60 will originate from the sump most distant from the desiccant inlet shown in the sump of sector 34 of chamber 30. In FIG. 1, this will impact the amount of liquid desiccant in sump sector 32A, in which to accommodate this change in volume there is provided a level controlling standpipe or conduit 48 which is considered part of the plumbing of system 10 and connected to heat exchanger 82 with a conduit 49. When the volume of liquid desiccant in sump sector 32A becomes high enough, the liquid desiccant from sump sector 32A passes into conduit 48 and then to heat exchanger 82 through conduit 49 where heat transfer takes place. A conduit 50 then transfers the liquid desiccant from heat exchanger 82 to the top of sector 63. When multiple sectors in each chamber are connected thermally to a single compressor, as is the case with sectors 33 and 34 of chamber 30 and sectors 63 and 64 of chamber 60, a migratory flow between such sectors allows the mass composition of the desiccant in one sector to alter the mass composition in the adjacent sector. These migratory flows are provided, in this preferred embodiment, by channel/opening 38 through sidewall 37A between sump sectors 32A and 32B, and by channel/opening 68 through sidewall 67A between sump sectors 62A and 62B.

Thus, it will be readily appreciated that the flow of air through chamber 30 becomes increasingly hot and humid as it passes through chamber 30 from inlet 30A to outlet 30B, and that the airflow through chamber 60 becomes increasingly cold and dry as it passes through chamber 60 from inlet 60A to outlet 60B. Again, this effect can be reversed by reversing the operation of thermal inducement apparatus 12 making the once hot side the cold side and the once cold side the hot side, or by way of reversing the plumbing, namely, plumbing sump sectors 32A and 32B for heat transfer with the cold side of thermal inducement apparatus 12 and plumbing sump sectors 62A and 62B for heat transfer with the hot side of thermal inducement apparatus 12.

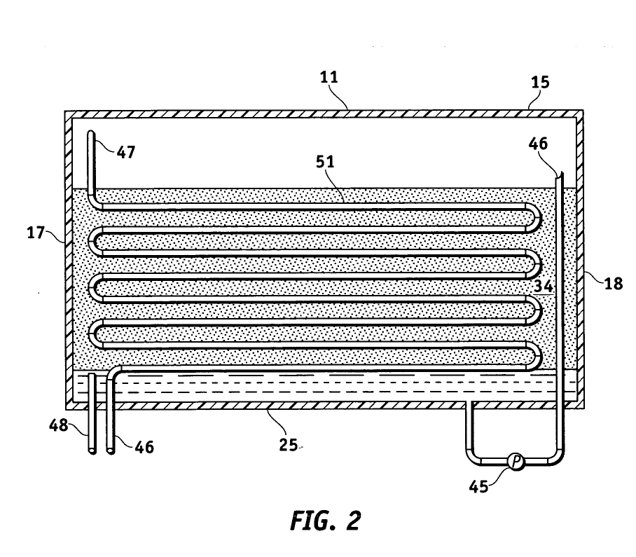

Looking now to FIG. 2, there is seen a partially schematic vertical sectional view of sector 34, constructed and arranged in accordance with an alternate embodiment of the invention. In FIG. 2, sector 34 includes opposing side walls 17 and 18, a length of top wall 15 and a length of bottom wall 25. Walls 17, 18, and 25 delineate sump sector 32B, which is the portion of sump 32 associated with sector 34. Pump 45 and conduit 46 are also depicted, the operation of which has been previously discussed in conjunction with FIG. 1. In this embodiment, direct thermal connection of sector 34 to thermal inducement apparatus 12 (not shown in FIG. 2) is provided with a heat exchange tube/conduit 51 located in the heat and mass transfer portion of sector 34, i.e., in the airflow path through sector 34. Heat exchange tube 51, which may have external fins or other surface augmentation designed to provide enhanced or improved heat transfer, is constructed from a conductive material that can withstand the corrosiveness of the liquid desiccant moving over its outside surfaces when the desiccant is in direct contact with the air stream. Such materials, for instance, can be special alloys of stainless steel, layered metals such as copper plated with nickel, a carbon-based conductive plastic, etc. As previously intimated, sector 34 will normally include a mechanism for enhancing the surface area contact between the airflow through sector 34 and the liquid desiccant passing through sector 34 and the heat exchange tube 51. As previously mentioned, suitable mechanisms can include media in sector 34 of the type typically found in evaporator cooler products, small saddles or rings found in smaller cooling towers, employment of one or more specialized nozzles for dispersing the liquid desiccant into sector in the form of small droplets, etc.

In the embodiment depicted in FIG. 2, the opposing ends of heat exchange tube 51 are coupled to conduits 46 and 47, respectively, in which conduit 46 is coupled to conduit 94 (FIG. 1) of thermal inducement apparatus 12, and conduit 47 is coupled to conduit 97 (FIG. 1) of thermal inducement apparatus 12. This arrangement eliminates the need for heat exchanger 96, because its heat transfer function is, in accordance with the embodiment depicted in FIG. 2, incorporated in sector 34 at pipe/conduit 51. In this embodiment, standpipe or conduit 48 is used in connection with sector 34 to direct a flow of the liquid desiccant from sector 34 of chamber 30 to a sector of chamber 60, while a controlled flow of liquid desiccant is brought from a sector of chamber 60 by means of flow through heat exchanger 82 and conduit 83. The sector configuration in FIG. 2 has no alteration in sector heat and mass transfer functions nor does it contain thermal alteration of heat transfer between refrigerant and desiccant. The modification in FIG. 2 reflects only the relocation of this heat transfer and the configuration presented may likewise be applied to sector 33 of chamber 30 and sectors 63 and 64 of chamber 60.

Because conduit 51 is coupled to thermal inducement apparatus 12 and is used to transfer heat in conjunction with thermal inducement apparatus 12, conduit 52 can be considered part of thermal inducement apparatus 12. Further, the embodiment depicted in FIG. 2 may be used along with a liquid desiccant heat exchange. In conjunction with FIG. 2, then, a further embodiment of the invention includes heat transfer conduit 51 of the thermal inducement apparatus 12 providing heat transfer at one of the sectors in conjunction with the substance providing heat and mass transfer at the one of the sectors, which, in FIG. 2, is sector 34.

It is to be understood that a combination of heat exchange tubes and refrigerant-to-liquid heat exchangers can be employed with thermal inducement apparatus 12, or that a single sector can utilize both a heat exchange tube and refrigerant-to-liquid heat exchanger.

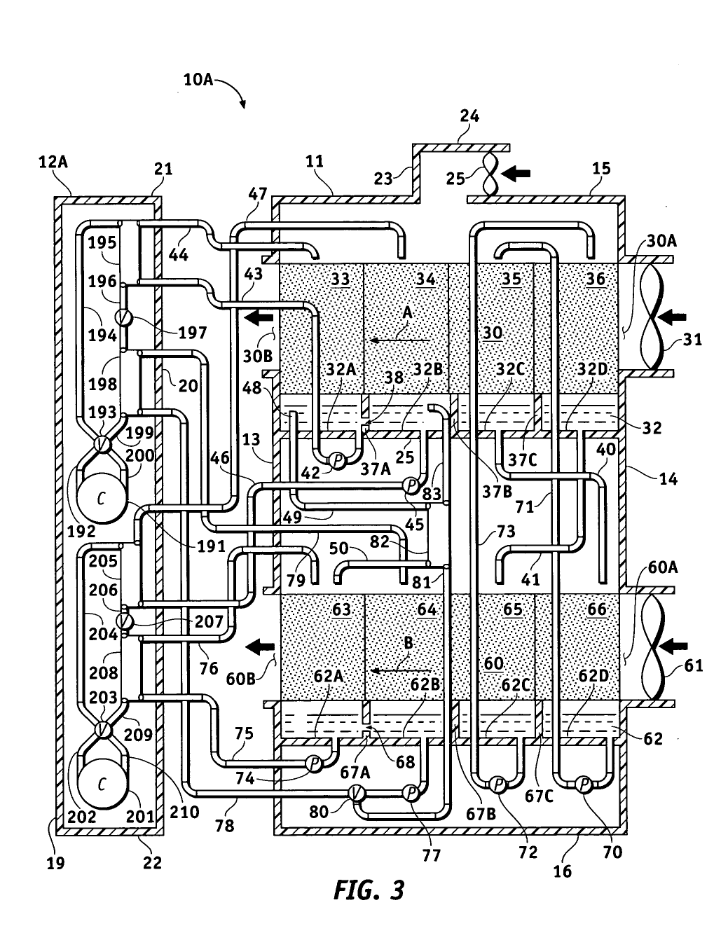

System 10 incorporates a single compressor, namely, compressor 91. Alternate embodiments of the invention incorporate thermal inducement apparatus incorporating multiple compressors including multiple hot sides and multiple cold sides, and just such an alternate embodiment of system is set forth in FIG. 3, which is denoted generally by the reference character 10A. In common to the embodiment 10 discussed in conjunction with FIG. 1, system 10A shares air handling apparatus 11 and the plumbing, which will not be again discussed. However, unlike thermal inducement apparatus 12, thermal inducement apparatus 12A in FIG. 3 is a multiple compressor system that includes two compressors, namely, compressor 191 and compressor 201.

FIG. 3 is particularly instructive as it shows an additional airflow inlet at top wall 15, which is formed by walls 23 and 24 and that incorporates a blower/fan for introducing additional airflow into chamber 30. This arrangement can be incorporated with the other system embodiments herein disclosed in FIGS. 1, 4, and 5, including any additional similar inlets, if desired.

Compressor 191 is conventional, in that it simply compresses a refrigerant thus making the refrigerant hot. The compressed, hot refrigerant flows through conduit 192 to a reversing valve 193, which directs the flow into conduit 194. The compressed, hot refrigerant flows through conduit 194 to a refrigerant-to-liquid heat exchanger 195, which is a multi-plate device made of stainless steel or other suitable material. Following heat exchange at exchanger 195, the refrigerant flows through conduit 196 to pressure expansion valve 197. Following its passage through valve 197, the refrigerant expands, thus becoming very cold. The refrigerant, now significantly reduced in temperature, is then directed from valve 197 to refrigerant-to-liquid heat exchanger 198 via a conduit, and from there through conduit 199 to reversing valve 193, which directs the flow of cold refrigerant into conduit 200, and which, in turn, directs the flow back to compressor 191 for recompression and recirculation. It will be understood that the side of thermal inducement apparatus 12A associated with compressor 191 upstream of valve 197 is one hot side of thermal inducement apparatus 12A, and that the side of thermal inducement apparatus 12A associated with compressor 191 downstream of valve 197 is one cold side of thermal inducement apparatus 12A.

Compressor 201 is also conventional, in that it simply compresses a refrigerant thus making the refrigerant hot. The compressed, hot refrigerant flows through conduit 202 to a reversing valve 203, which directs the flow into conduit 204. The compressed, hot refrigerant flows through conduit 204 to a refrigerant-to-liquid heat exchanger 205, which is a multi-plate device made of stainless steel or other suitable material. Following heat exchange at exchanger 205, the refrigerant flows through conduit 206 to pressure expansion valve 207. Following its passage through valve 207, the refrigerant expands, thus becoming very cold. The refrigerant, now significantly reduced in temperature, is then directed from valve 207 to refrigerant-to-liquid heat exchanger 208 via a conduit, and from there through conduit 209 to reversing valve 203, which directs the flow of cold refrigerant into conduit 210, and which, in turn, directs the flow back to compressor 201 for recompression and recirculation. It will be understood that the side of thermal inducement apparatus 12A associated with compressor 201 upstream of valve 207 is another hot side of thermal inducement apparatus 12A, and that the side of thermal inducement apparatus 12A associated with compressor 201 downstream of valve 207 is another cold side of thermal inducement apparatus 12A.

In the embodiment depicted in FIG. 3, sector 33 of chamber 30 is thermally connected to a hot side of thermal inducement apparatus 12A associated with compressor 191 by a flow of the liquid desiccant, which is provided by pump 42 pumping the liquid desiccant from sump sector 32A through conduit 43 to refrigerant-to-liquid heat exchanger 195 where it passes the refrigerant, in which an exchange of heat is produced between the flow of the refrigerant and the flow of the liquid desiccant at exchanger 195, and in which the liquid desiccant, now heated, passes to the top of sector 33 through conduit 44 and into the air stream passing through chamber 30, and which is then collected in sump sector 32A. In the case in which multiple sectors in each chamber are influenced by thermal inducement, sector 34 is also thermally connected to a hot side of thermal inducement apparatus 12A by a flow of the liquid desiccant provided by a pump 45 pumping the liquid desiccant from sump sector 32B through conduit 46 to refrigerant-to-liquid heat exchanger 205 where it passes the refrigerant, in which an exchange of heat is produced between the flow of the refrigerant and the flow of the liquid desiccant at exchanger 205, and in which the liquid desiccant, now heated, passes to the top of sector 34 through conduit 47 and into the air stream passing through chamber 30, which is then collected in sump sector 32B.

Sector 63 of chamber 60 is thermally connected to a cold side of thermal inducement apparatus 12A by a flow of the liquid desiccant, which is provided by pump 74 pumping the liquid desiccant from sump sector 62A through conduit 75 to refrigerant-to-liquid heat exchanger 208 where it passes the refrigerant, in which an exchange of heat is produced between the flow of the refrigerant and the flow of the liquid desiccant at exchanger 208, and in which the liquid desiccant, now cooled, passes to the top of sector 63 through conduit 76 and into the air stream passing through chamber 60, which is then collected in sump sector 62A. In the case in which multiple sectors in each chamber are influenced by thermal inducement, sector 64 is also thermally connected to a cold side of thermal inducement apparatus 12A by a flow of the liquid desiccant provided by a pump 77 pumping the liquid desiccant from sump sector 62B through conduit 78 to refrigerant-to-liquid heat exchanger 198 where it passes the refrigerant, in which an exchange of heat is produced between the flow of the refrigerant and the flow of the liquid desiccant at exchanger 198, in which the liquid desiccant, now cooled, passes to the top of sector 64 through conduit 79 and into the air stream passing through chamber 60, which is then collected in sump sector 62B.

In accordance with this arrangement, as is also the case with system 10, as there develops change in the mass composition (i.e., water content) of the liquid desiccant in sectors 63 and 64 in system 10A in the opposite concentration from liquid desiccant in sectors 33 and 34, an interchange flow between chambers 30 and 60 is necessary to maintain this compositional change.

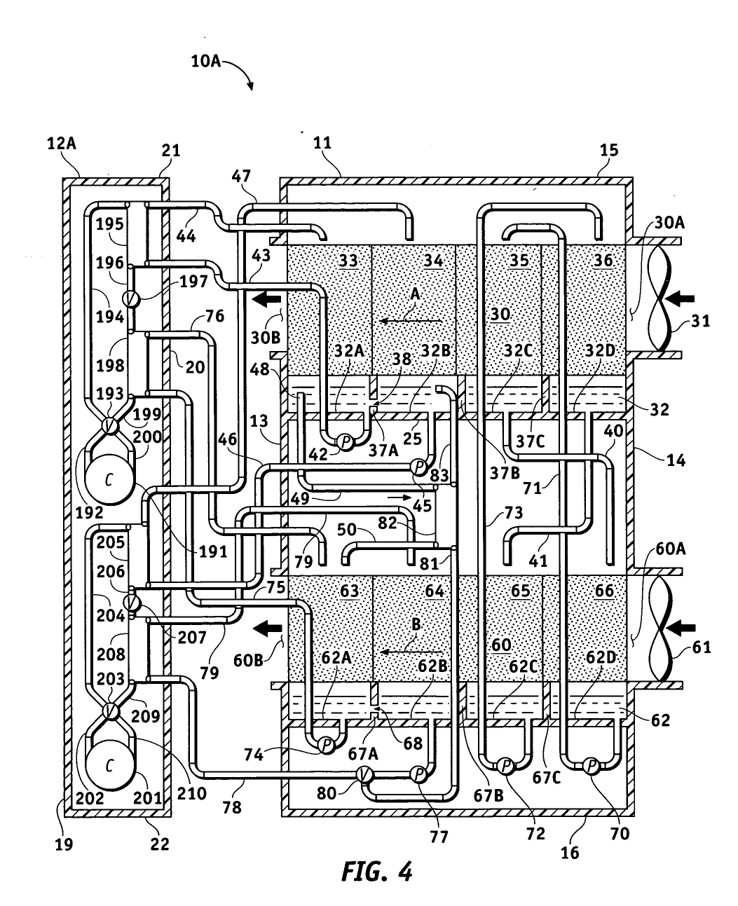

And so system 10 incorporates a single compressor, namely, compressor 91, and system 10A incorporates multiple compressors, namely, compressors 191 and 201. As a matter of illustrating yet another embodiment, FIG. 4 illustrates system 10A with an alternate plumbing arrangement between sectors 63 and 64 and thermal inducement apparatus 12A.

In the embodiment depicted in FIG. 4, sector 63 of chamber 60 is thermally connected to a cold side of thermal inducement apparatus 12A by a flow of the liquid desiccant, which is provided by pump 74 pumping the liquid desiccant from sump sector 62A through conduit 75 to refrigerant-to-liquid heat exchanger 198 where it passes the refrigerant, in which an exchange of heat is produced between the flow of the refrigerant and the flow of the liquid desiccant at exchanger 198, and in which the liquid desiccant, now cooled, passes to the top of sector 63 through conduit 76 and into the air stream passing through chamber 60, which is then collected in sump sector 62A. In the case in which multiple sectors in each chamber are influenced by thermal inducement, sector 64 is also thermally connected to a cold side of thermal inducement apparatus 12A by a flow of the liquid desiccant provided by a pump 77 pumping the liquid desiccant from sump sector 62B through conduit 78 to refrigerant-to-liquid heat exchanger 208 where it passes the refrigerant, in which an exchange of heat is produced between the flow of the refrigerant and the flow of the liquid desiccant at exchanger 208, in which the liquid desiccant, now cooled, passes to the top of sector 64 through conduit 79 and into the air stream passing through chamber 60, which is then collected in sump sector 62B.

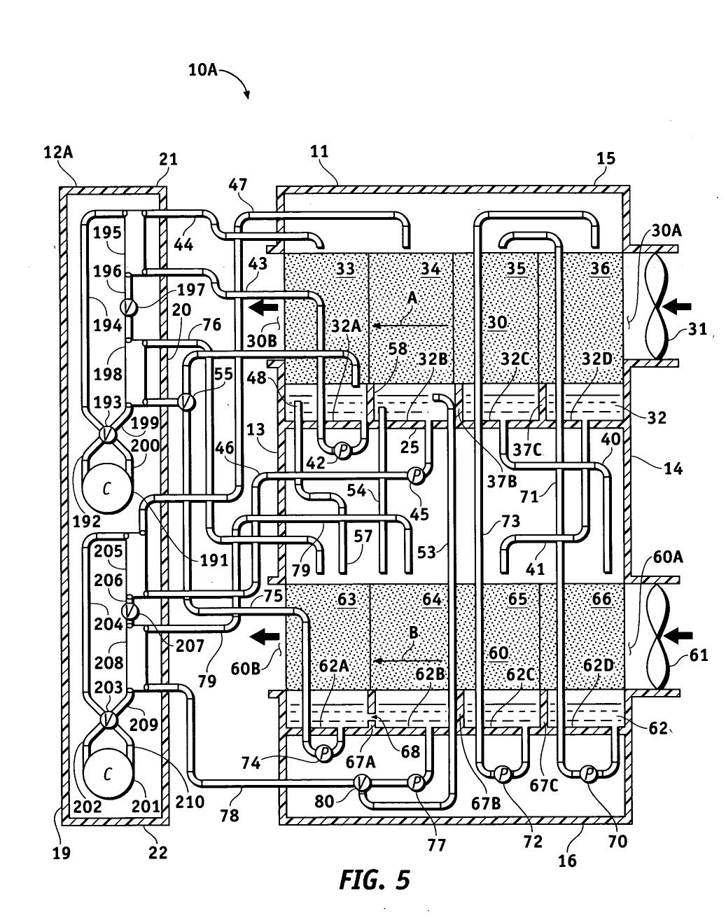

FIG. 5 illustrates yet another configuration of system 10A from its configuration shown in FIG. 4. In the embodiment of system 10A depicted in FIG. 5, an alternate way to mitigate attainment of sector equilibrium between its desiccant and its passing air stream by individual sector transfer between chambers 30 and 60 is presented, in which valve 80 in conduit 78 redirects a portion of the liquid desiccant flow from pump 77 into sump sector 32B through a conduit 53. In this embodiment, there is no heat exchanger associated with conduit 53. A standpipe or conduit 54 is provided, which returns the liquid desiccant to sector 64 from sump sector 32B of sector 34. Furthermore, sector 63 of chamber 60 is thermally connected to a cold side of thermal inducement apparatus 12A by a flow of the liquid desiccant, which is provided by pump 74 pumping the liquid desiccant from sump sector 62A through conduit 75 to a valve 55, which directs a portion of the liquid desiccant to exchanger 198 where it passes the refrigerant, in which an exchange of heat is produced between the flow of the refrigerant and the flow of the liquid desiccant at exchanger 198, and in which the liquid desiccant, now cooled, passes to the top of sector 63 through conduit 76 and into the air stream passing through chamber 60, which is then collected in sump sector 62A. Valve 55 also draws of a portion of the liquid desiccant away from exchanger 198 to sump sector 32A of sector 33, in which another standpipe or conduit 57 is provided for returning liquid desiccant from sump sector 32A to the top of sector 63 and into the air stream passing therethrough and through chamber 60, which is then collected in sump sector 62A. There being no controlled migratory flow of liquid desiccant between sectors, wall 58 is exhibited extending the sump height. Wall 67A is shown with an optional opening 68, now utilized for level control between the relevant sectors, but this is not necessary in this embodiment. While not shown, liquid-to-liquid heat exchanges similar to liquid-to-liquid heat exchanger 82 may be utilized with conduits 53 and 54, as well as with conduit 57.

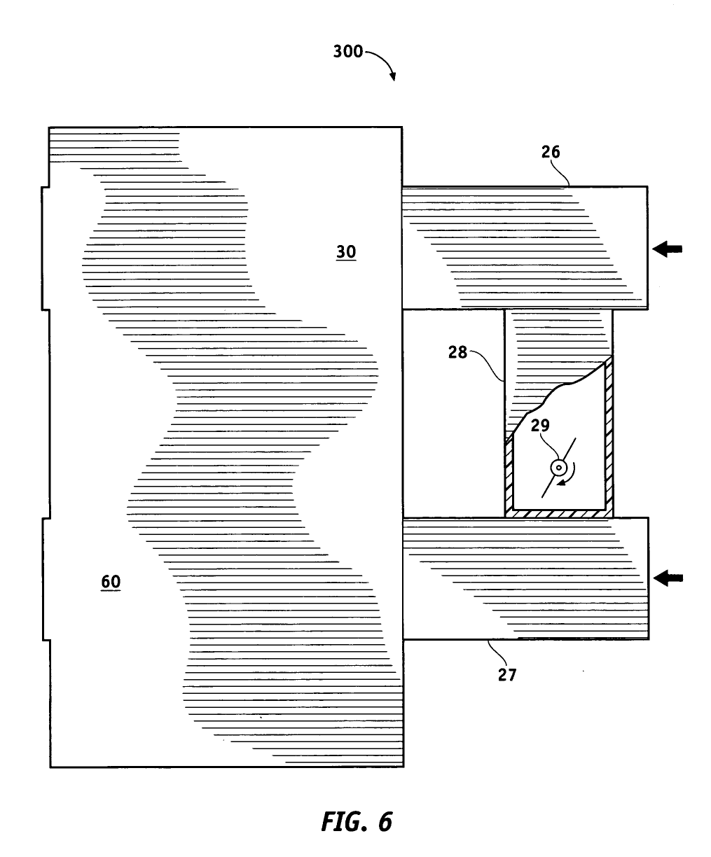

With momentary reference to FIG. 6, a duct assembly 300 is shown, which may be used with the preferred embodiments of the invention herein disclosed. Duct assembly 300 is instructive for showing a concurrent, parallel airflow arrangement of chamber 30 relative to chamber 60. Ducts 26 and 27 are shown attached to chambers 30 and 60 respectively. Interconnecting ducts 26 and 27 is a plenum 28 containing airflow control 29, which is a fan or blower, and which provides for an optional mixing of intake air from duct 26 with intake air from duct 27. Other duct configurations may be used with the various embodiments of the invention without departing from the teachings set forth herein.

Partial heat and mass energy change to an air stream can be accomplished without the inclusion of a heat and mass transfer substance. For instance, heat transfer from a finned coil containing refrigerant, such as is found in conventional air conditioners, can be employed to perform simple heat transfer thereby changing the temperature of the air. The resultant ability to alter the air humidity would be dependent upon the characteristics of the air.

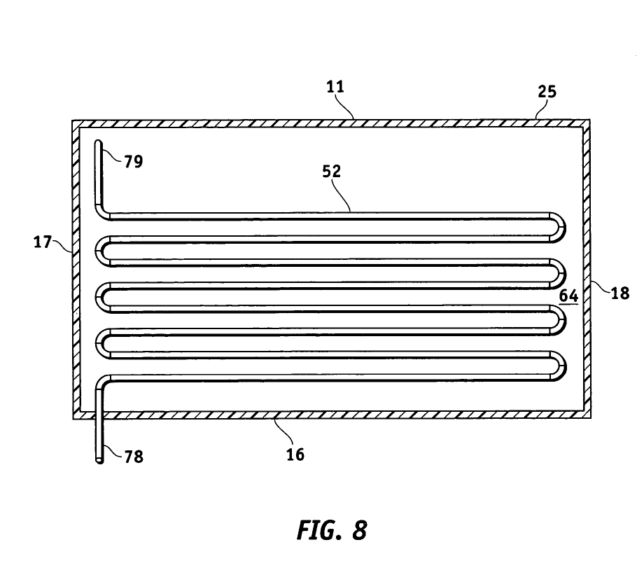

Referring now to FIG. 8, there is seen a partially schematic vertical sectional view of sector 64 including opposing side walls 17 and 18, a length of wall 25 and a length of wall 16. In this embodiment, there is no heat and mass transfer substance present in sector 64. Direct thermal connection of sector 64 to thermal inducement device 12 (not shown in FIG. 8) is provided with a heat exchange tube/conduit 52, that circulates liquid desiccant, located in the heat and mass transfer portion of sector 64, i.e., in the airflow path through sector 64. Heat exchange tube 52, which may have external fins or other surface augmentation designed to provide enhanced heat transfer is constructed from a conductive material such as copper or aluminum or the like.

In the embodiment depicted in FIG. 8, the opposing ends of heat exchange tube/conduit 52 are coupled to conduits 78 and 79, respectively, as they are arranged in the embodiment of FIG. 1. The modification set forth in FIG. 8 does not alter the heat and mass transfer functions as tube 52 provides approximately the same air temperature and humidity modification as an evaporator coil performs in a conventional air conditioner. With this arrangement, the heat and mass transfer function provided by the liquid desiccant at sector 64 in the embodiment depicted in FIG. 1 is no longer necessary and is eliminated, as the heat transfer function is now replaced with heat transfer pipe/conduit 52. Consistent with this description of the embodiment of FIG. 8, it will be understood that a combination of heat exchange tubes and refrigerant-to-liquid heat exchangers can be employed with thermal inducement apparatus 12.

Because conduit 52 is coupled to thermal inducement apparatus 12 and is used to transfer heat in conjunction with thermal inducement apparatus 12, conduit 52 can be considered part of thermal inducement apparatus 12. Further, the embodiment depicted in FIG. 8, like the embodiment depicted in FIG. 2, may be used along with a liquid desiccant heat exchange. In conjunction with FIG. 8, then, a further embodiment of the invention includes heat transfer conduit 52 of the thermal inducement apparatus 12 providing heat transfer at one of the sectors in conjunction with the substance providing heat and mass transfer at the one of the sectors, which, in FIG. 8, is sector 64.

The present invention is described above with reference to preferred embodiments. However, those skilled in the art will recognize that changes and modifications may be made in the described embodiments without departing from the nature and scope of the present invention, and that the various elements of the invention may be multiplied as needed for accommodating specific needs. Various changes and modifications to the embodiments herein chosen for purposes of illustration will readily occur to those skilled in the art. To the extent that such modifications and variations do not depart from the spirit of the invention, they are intended to be included within the scope thereof.

Having fully described the invention in such clear and concise terms as to enable those skilled in the art to understand and practice the same, what is claimed is:

1. Apparatus comprising:
a first chamber having a plurality of first sectors;
a second chamber having a plurality of second sectors;
a first airflow device forming a first airflow through the first chamber;
a second airflow device forming a second airflow through the second chamber;
a heat and mass transfer substance flowing in a plurality of the first and second sectors, the substance interacting with the first and second airflows through the first and second chambers;
thermal inducement apparatus thermally interacting with the substance establishing a thermal gradient between the first sectors and a thermal gradient between the second sectors providing a heat and mass energy gradient for the first airflow through the first sectors and a reversed heat and mass energy gradient for the second airflow through the second sectors; and
plumbing moving the substance between at least one of the first sectors and at least one of the second sectors.

2. Apparatus according to claim 1, further comprising an energy exchange device causing the substance to provide heat and mass transfer between the first air flow and the second air flow.

3. Apparatus according to claim 2, wherein the energy exchange device includes a carrier that is wetted with the liquid desiccant.

4. Apparatus according to claim 1, wherein the substance includes a liquid desiccant.

5. Apparatus according to claim 1, further comprising a channel permitting the substance to migrate between ones of the first sectors.

6. Apparatus according to claim 1, further comprising a channel permitting the substance to migrate between ones of the second sectors.

7. Apparatus according to claim 1, wherein the thermal inducement apparatus includes a compressor.

8. Apparatus according to claim 1, wherein the thermal inducement apparatus includes compressors.

9. Apparatus according to claim 8, wherein each of the compressors is thermally connected to plumbing for exchanging the substance between one of the first sectors and one of the second sectors.

10. Apparatus according to claim 1, further including a heat transfer conduit of the thermal inducement apparatus providing heat transfer at one of the sectors.

11. Apparatus according to claim 1, further including a heat transfer conduit of the thermal inducement apparatus providing heat transfer at one of the sectors in conjunction with the substance providing heat and mass transfer.

12. Apparatus according to claim 1, further comprising:
the first airflow having a first flow rate; and
the second airflow having a second flow rate;
wherein the first flow rate is different from the second flow rate.

13. Apparatus comprising:
air movement apparatus developing a first airflow through a first chamber and a second airflow through a second chamber, the first chamber having a first sector and the second chamber having a second sector;
a substance capable of transferring heat and mass;
an energy exchange device causing the first airflow to interact with the substance at the first sector and the second airflow interacting with the substance at the second sector, and forming a heat and mass transfer exchange between the first and second airflows;
thermal inducement apparatus thermally interacting with the substance causing an energy change transmitted to the first airflow and an opposite energy change transmitted to the second airflow; and
plumbing providing a flow of the substance of the first sector to the second sector, and a flow of the substance of the second sector to the first sector.

14. Apparatus according to claim 13, wherein the energy exchange device includes a carrier that is wetted with the liquid desiccant.

15. Apparatus according to claim 13, wherein the substance includes a liquid desiccant.

16. Apparatus according to claim 13, further comprising:
the first airflow having a first flow rate; and
the second airflow having a second flow rate;
wherein the first flow rate is different from the second flow rate.

17. Apparatus according to claim 13:
wherein the first sector is one of a plurality of sectors of the first chamber; and
the first airflow interacting with the substance at each of the plurality of sectors of the first chamber.

18. Apparatus according to claim 17, further comprising a channel permitting the substance to migrate between ones of the sectors of the first chamber.

19. Apparatus according to claim 13:
wherein the second sector is one of a plurality of sectors of the second chamber;
and the second airflow interacting with the substance at each of the plurality of sectors of the second chamber.

20. Apparatus according to claim 19, further comprising a channel permitting the substance to migrate between ones of the sectors of the second chamber.

21. Apparatus according to claim 13, wherein the thermal inducement apparatus includes a compressor.

22. Apparatus according to claim 13, wherein the thermal inducement apparatus includes multiple compressors.

23. A method comprising steps of:
applying a heat and mass transfer substance to sectors of a first chamber;
applying the heat and mass transfer substance to sectors of a second chamber;
intermixing the substance between first chamber sectors and second chamber sectors;
adapting the substance of the first chamber sectors to contact air flowing into the space;
adapting the substance of the second chamber sectors to contact air flowing from the space;
establishing a negative thermal gradient between sectors in the first chamber; and
establishing a positive thermal gradient between sectors in the second chamber.

24. The method according to claim 23, further comprising implementing thermal gradients with a thermal inducement device.

25. The method according to claim 23, further comprising implementing thermal gradients with multiple thermal inducement devices.
